(19) United States
(12) Patent Application Publication
(10) Pub. No.: US 2025/0341267 A1
(43) Pub. Date: Nov. 6, 2025

(54) Multi-Diameter Retainer

(71) Applicant: Illinois Tool Works Inc., Glenview, IL (US)

(72) Inventor: Paul D. Barkauski, New Lenox, IL (US)

(21) Appl. No.: 19/191,135

(22) Filed: Apr. 28, 2025

Related U.S. Application Data
(60) Provisional application No. 63/641,615, filed on May 2, 2024.

(51) Int. Cl. F16L 3/123

(52) U.S. Cl. CPC F16L 3/1236

(57) ABSTRACT

Disclosed is a multi-stop retainer to secure objects of varying diameters. The multi-stop retainer includes a lid coupled to a base, a first leg member, and a second leg member. The lid is coupled to the base via a hinge at the first end. The lid includes a ratchet coupler at the second end of the lid that includes a first latch and a second latch. The first leg member is coupled to the base and includes a first plurality of mechanical stops along its length that interface with the first latch. The second leg member is coupled to the base and includes a second plurality of mechanical stops along its length to interface with the second latch. The first leg member and the second leg member are parallel relative to one another. The lid pivots relative to the base via the hinge to define a pocket configured to be sized for securing an object via the ratchet coupler, the first leg member, and the second leg member.

### CROSS-REFERENCE

The present application claims priority to U.S. Provisional Patent Application No. 63/641,615, filed May 2, 2024, and entitled “Multi-Diameter Tube/Cable Retainer,” which is hereby incorporated by reference in its entirety.

### BACKGROUND

Automotive components require fastening solutions that are simple to manufacture, easy to assemble, and, above all, reliable and efficient in use. Original equipment manufacturers (OEMs) frequently seek retention clips capable of securing tubes, wire bundles, and similar components that vary in diameter. In many cases, it is desirable to efficiently attach one or more such components—such as wire bundles and convolute sleeves—to a vehicle structure. For example, wire bundles are often enclosed in flexible, lightweight, corrugated tubing commonly referred to as convolute tubing.

Many conventional fastening solutions lack sufficient adjustability and are therefore unable to retain components across a broad range of diameters. These conventional solutions typically fall into two main categories: (i) rigid clips, which offer strong retention and resistance to axial movement but are only effective for a narrow range of diameters, and (ii) flexible clips, which can accommodate various diameters but provide insufficient retention force and poor slide resistance. Thus, there remains an unmet need for a retention device that can securely hold tubes and wire bundles of varying sizes while maintaining high performance without relying solely on flexible retention elements.

In practice, this lack of adjustability often necessitates the design and production of multiple diameter-specific clips, increasing part complexity, inventory, and tooling costs at the manufacturing level. Other adjustable retention solutions, such as straps or zip ties, require secondary tooling steps to achieve adequate retention, along with additional trimming operations to remove excess material post-assembly. These extra steps lead to increased material waste and longer assembly times. Furthermore, metal-based retention products, while offering strength, are heavier, more expensive, and typically require specialized tools (e.g., screwdrivers) for installation. Although plastic clips are lighter, they tend to lack the structural integrity to support larger or heavier components, often resulting in sagging or drooping after installation.

Accordingly, there is a need for an improved lightweight retainer that can reliably and rigidly secure components such as wires and tubes to a vehicle structure, while accommodating a wide range of diameters. Such a solution should reduce part complexity, eliminate wasteful installation steps, and provide robust performance without reliance on external tools or flexible retention mechanisms alone.

### SUMMARY

The present disclosure relates generally to a retainer for attaching objects of various diameters, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric view of a ratcheting system having a multi-stop retainer in accordance with an aspect of this disclosure.

FIG. 1b illustrates a side elevation view of the ratcheting system secured with an object.

FIGS. 2a and 2b illustrate, respectively, top, and bottom isometric views of the multi-stop retainer in accordance with an aspect of this disclosure where the multi-stop retainer is in an open position.

FIGS. 2c through 2f illustrate first, second, third, and fourth side views of multi-stop retainer.

FIGS. 2g and 2h illustrate, respectively, top, and bottom top plan views of the multi-stop retainer.

FIGS. 3a through 3d illustrate, respectively, top isometric views of the multi-stop retainer in the open position, a first closed position, a second closed position, and a third closed position.

FIGS. 3e through 3h illustrate, respectively, side elevation views of the multi-stop retainer in the open position, the first closed position, the second closed position, and the third closed position.

FIG. 4 illustrates a top isometric view of the multi-stop retainer in accordance with another aspect of this disclosure where the multi-stop retainer is in the first closed position.

FIGS. 5a and 5b illustrate, respectively, isometric and side elevation views of the multi-stop retainer in accordance with another aspect of this disclosure where the multi-stop retainer is in the open position.

FIGS. 5c through 5e illustrate, respectively, side elevation views of the multi-stop retainer of FIGS. 5a and 5b in the first closed position, the second closed position, and the third closed position.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to retention devices and, more particularly, to a fastener or clip capable of retaining a range of object diameters (e.g., tubes and wire bundles) within a single structure while maintaining consistent retention and slide resistance performance. A multi-stop retainer can employ a hinged pocket and lid configuration capable of securely retaining objects (e.g., tubes or wire bundles) of multiple diameters within a single pocket structure. The multi-stop retainer includes a set of mechanical stops formed along a pair of opposing leg members. These mechanical stops can be configured to engage a full-width dual-plate J-shaped latch integrated into the lid, allowing the fastener to selectively clamp over a range of diameters without compromising retention or requiring separate clips for each size.

The multi-stop retainer provides a tunable retention system whereby the position, spacing, and number of mechanical stops may be customized to optimize engagement for targeted diameter ranges. The configuration permits the J-shaped latch to engage both leg members simultaneously or individually, thereby increasing the versatility of the fastening mechanism. In certain examples, an optional flexible retention feature may be position in or integrated into the pocket to increase slide resistance without serving as the primary retention means. The fastener is designed for manufacture via two-plate injection molding or three-dimensional (3D) printing processes.

The design of the multi-stop retainer offers strong retention and slide force resistance across various tube and wire bundle diameters, eliminating the need for multiple diameter-specific clips. The multi-stop retainer allows for tuning of retention characteristics, while compatibility with standard injection molding processes supports efficient manufacturing. Additionally, it reduces part complexity, tooling needs, and inventory requirements for OEMs.

In one example, a multi-stop retainer configured to secure objects of varying diameters comprises: a lid coupled to a base via a hinge at a first end and comprising a ratchet coupler at a second end of the lid, wherein the ratchet coupler comprises a first latch and a second latch; a first leg member coupled to the base and comprising a first plurality of mechanical stops along its length that are configured to interface with the first latch; and a second leg member coupled to the base and comprising a second plurality of mechanical stops along its length that are configured to interface with the second latch, and wherein the first leg member and the second leg member are parallel relative to one another, and wherein the lid is configured to pivot via the hinge to define a pocket configured to be sized for securing an object via the ratchet coupler, the first leg member, and the second leg member.

In another example, a multi-stop retainer configured to secure objects of varying diameters comprises: a lid coupled to a base via a hinge at a first end and comprising a ratchet coupler at a second end of the lid; and a pair of leg members, wherein each of the pair of leg members comprises a plurality of mechanical stops along its length, and wherein the plurality of mechanical stops is configured to interface with the ratchet coupler to define a pocket configured to be sized for securing an object.

In some examples, the ratchet coupler is configured to engage each of the pair of leg members simultaneously.

In some examples, the plurality of mechanical stops is non-uniformly spaced.

In some examples, the plurality of mechanical stops is uniformly spaced.

In some examples, the multi-stop retainer further comprises flexible retention structure disposed within the pocket and configured to enhance slide resistance. In one example, the flexible retention structure is a resilient ridge extending laterally across a majority of a width of the lid. In another example, the flexible retention structure is a linear protrusion extending transversely relative to the width of the lid. The linear protrusion can extend from a cutout formed in the lid.

In some examples, the ratchet coupler comprises a first latch and a second latch.

In some examples, the ratchet coupler comprises a first plate that is transverse relative to the second plate, wherein the first latch and the second latch are coupled to the second plate and configured to engage one or more of the plurality of mechanical stops.

In some examples, the first plate is positioned between the first latch and the second latch.

In some examples, each of the first latch and the second latch is a J-shaped latch.

In some examples, the pair of leg members comprises a first leg member parallel to a second leg member that is offset vertically by a first distance relative to the first leg member.

In some examples, the ratchet coupler comprises a first latch configured to engage the first leg member, and a second latch configured to engage the second leg member.

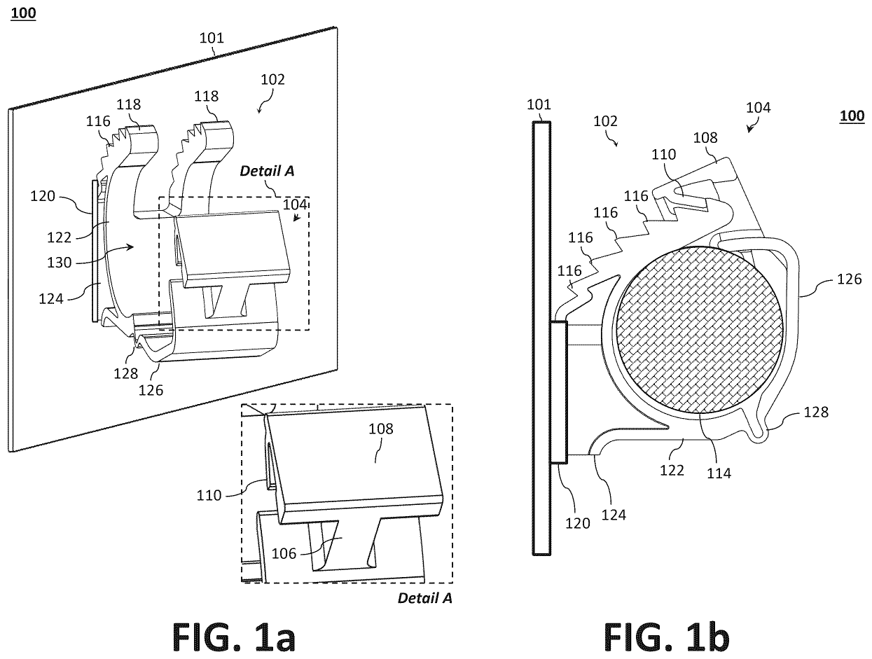

FIG. 1a illustrates an isometric view of a ratcheting system 100 having a multi-stop retainer 102 in accordance with an aspect of this disclosure, while FIG. 1b illustrates a side elevation view of the ratcheting system 100 secured with an object 114. The illustrated ratcheting system 100 includes a multi-stop retainer 102 configured to attach the object 114 relative to a component 101 via a fastener assembly.

The component 101 may be, for example, a panel (e.g., an automotive panel), frame (e.g., an automotive frame), or other structural components. Depending on the application, the component 101 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

The object 114 is illustrated as having a generally circular outer surface. The object 114 may be or include, for example, wire bundles, convolute sleeves, tubes, hoses, or the like. For example, in an electric vehicle, the objects 114 may include one or more cable bundles that can be secured to the component 101 via the multi-stop retainer 102. In other examples, the objects 114 may be fluid lines (e.g., coolant lines, fuel lines, brake lines, HVAC lines, etc.).

The multi-stop retainer 102 includes a base 122, a plurality of leg members 118, a lid 126 coupled to the base 122 via a hinge 128, and a ratchet coupler 104 coupled to the lid 126 and configured to engage the plurality of leg members 118. In one example, the fastener assembly comprises a first fastener feature 120 (e.g., a first doghouse feature) formed in or on the component 101 and a second fastener feature 124 (e.g., a second doghouse feature) formed in or on the multi-stop retainer 102.

While the fastener assembly is illustrated as a doghouse assembly, other fastening arrangements are contemplated, including openings formed in the component 101 and fasteners formed on the multi-stop retainer 102, such as W-type fasteners, pin clips, box-prong fasteners, push-pin fasteners (sometimes referred to as trees, pine trees, Christmas trees, etc.), and the like.

Depending on the application, the illustrated multi-stop retainer 102 may be fabricated from, for example, synthetic or semi-synthetic polymers (e.g., plastics such as acrylonitrile butadiene styrene (ABS), polyvinyl chloride (PVC), etc.), composite materials (e.g., fiberglass), or a combination thereof. In some examples, the multi-stop retainer 102 may be formed as a unitary structure via an injection molding technique or using additive manufacturing techniques. For instance, the multi-stop retainer 102 may be fabricated as a single component via a plastic injection process. In another example, the multi-stop retainer 102 may be formed as a printed thermoplastic component that can be manufactured with high accuracy and intricate detail, which is particularly advantageous for components requiring complex and/or precise features. Additive manufacturing techniques eliminate the need for mold tooling typically associated with injection molding, thereby reducing up-front manufacturing costs, which are especially beneficial in low-volume production. In some examples, the multi-stop retainer 102 may be co-fabricated with the component 101 using material extrusion (e.g., fused deposition modeling (FDM)), stereolithography (SLA), selective laser sintering (SLS), material jetting, binder jetting, powder bed fusion, directed energy deposition, vat photopolymerization, or any other suitable additive manufacturing/3D printing process. In certain implementations, portions of the multi-stop retainer 102 may be printed at different resolutions during a single operation.

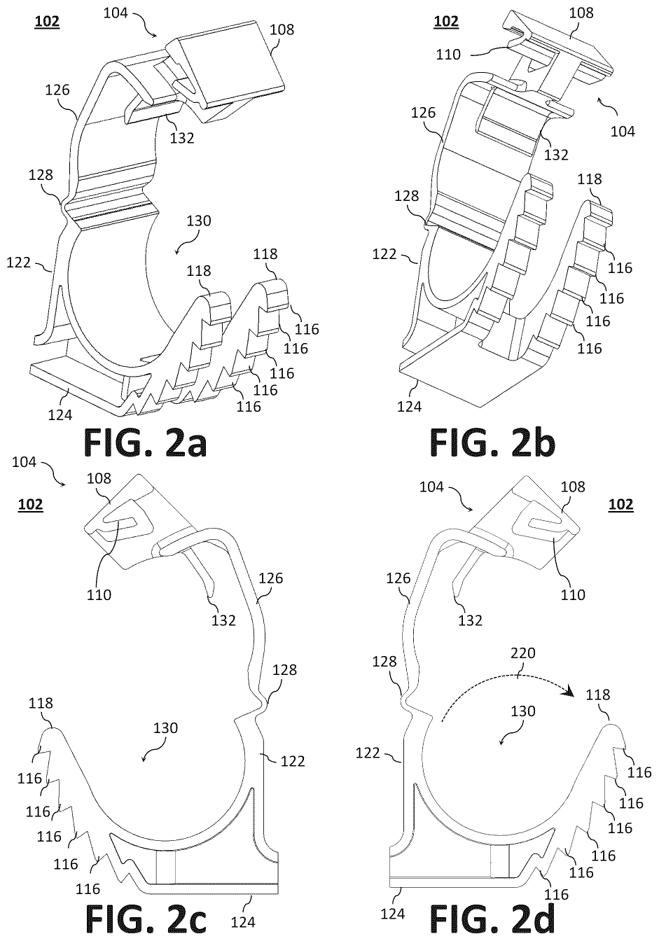

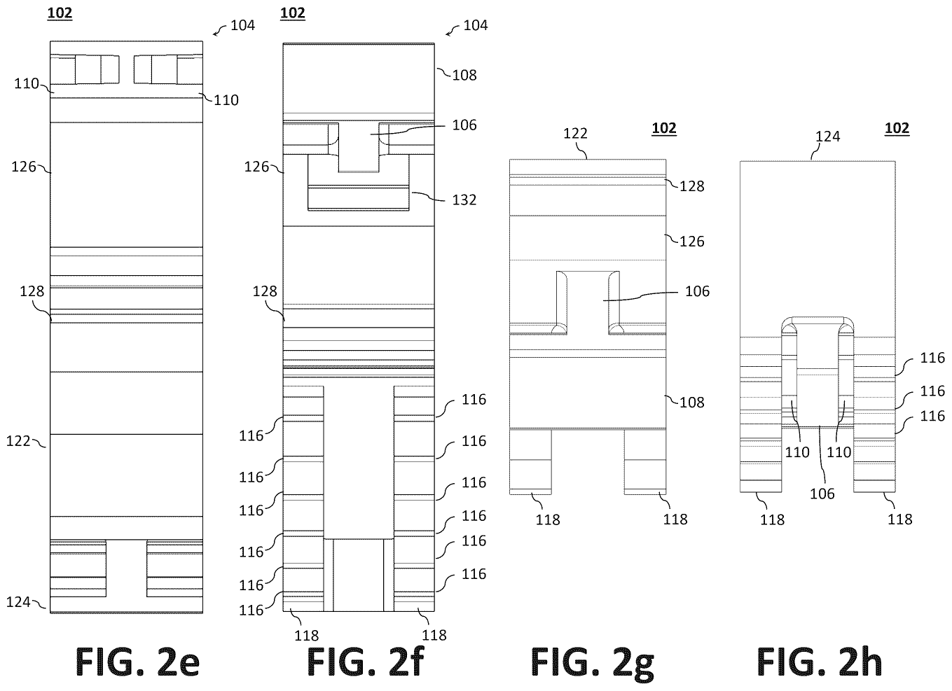

FIGS. 2a and 2b illustrate top and bottom isometric views, respectively, of the multi-stop retainer 102 in an open position, while FIGS. 2c through 2f show first through fourth side views, and FIGS. 2g and 2h depict top and bottom plan views of the multi-stop retainer 102.

The base 122 is configured to define a pocket 130 for receiving the object 114. In some examples, the base 122 may be configured to couple to the component 101 via the second fastener feature 124 formed on the base 122 and the first fastener feature 120 formed on the component 101.

A plurality of leg members 118 extend upward and away from the base 122. As illustrated, the leg members 118 may be arranged as a pair of spaced-apart, opposing members. In the illustrated example, the leg members 118 are parallel to one another and generally curved.

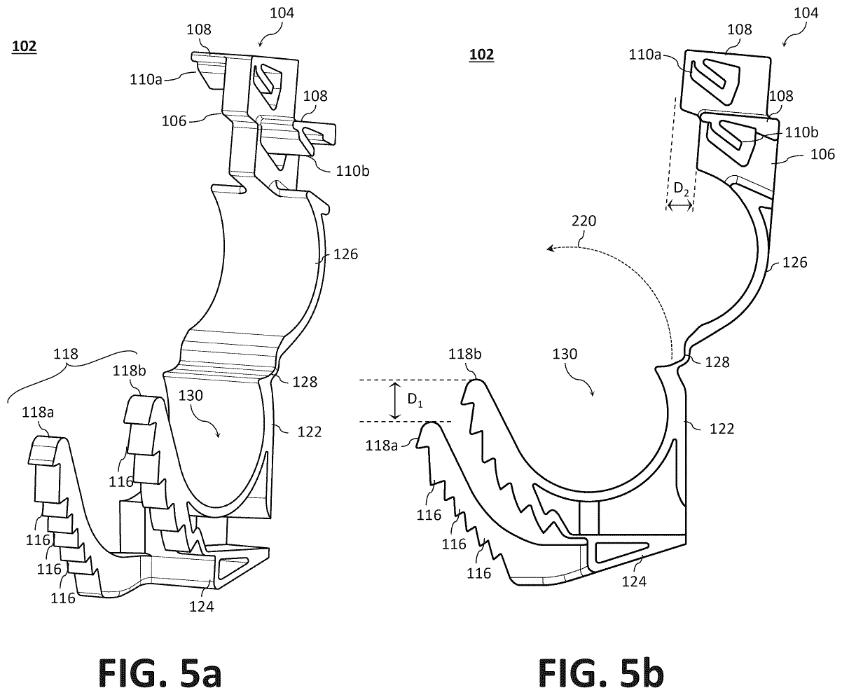

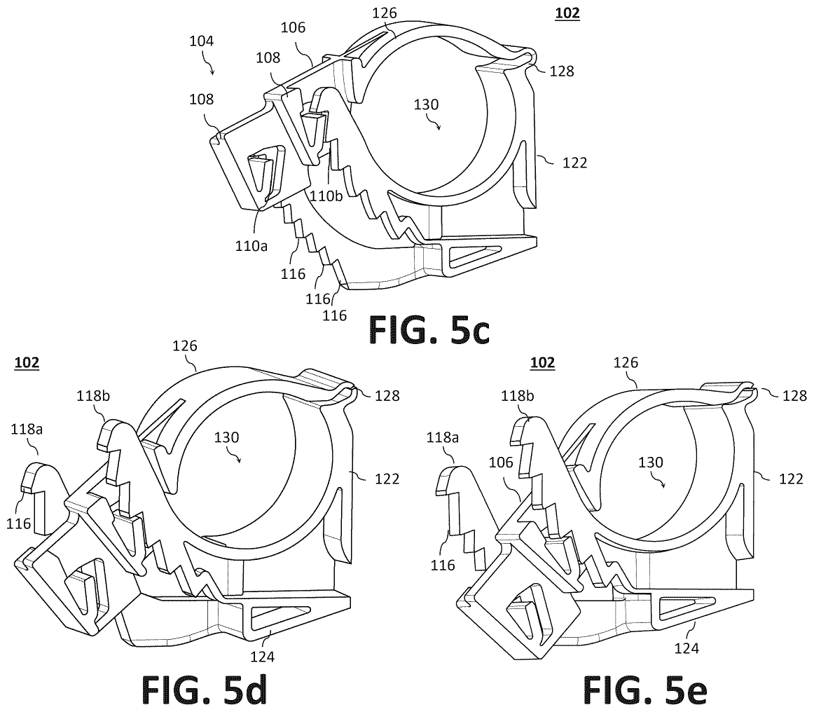

Each leg member 118 includes a plurality of mechanical stops 116 (e.g., teeth or notches defining discrete stops). These mechanical stops 116 provide discrete landing or engagement surfaces positioned at varying intervals along the length of each leg member 118. The leg members 118 may incorporate asymmetric or offset spacing of the mechanical stops 116 to allow finer resolution in diameter clamping. For example, one leg member 118 may have more closely spaced mechanical stops 116 than the opposing leg member. In some cases, the spacing may be uniform or variable along the length of a given leg member 118. Further, the size of the mechanical stops can vary as illustrated in FIGS. 5a through 5e.

The lid 126 is rotatably or pivotally connected to the base 122 via a hinge 128, which may be a living hinge, a butt hinge with a pivot pin, or another suitable type. The illustrated ratchet coupler 104 extends laterally across the full width of the lid 126 and includes a latch 110 configured to engage one or more of the mechanical stops 116 on one or both leg members 118.

The ratchet coupler 104 comprises a first plate 106, a second plate 108, and a pair of latches 110 (e.g., J-shaped latches), and can thus be configured as a dual-plate latch. Each latch 110 is designed to engage one or more of the mechanical stops 116 on a corresponding leg member 118. In the illustrated configuration, the latches 110 are mounted on the second plate 108 and positioned on either side of the first plate 106. For example, the first and second plates 106, 108 are arranged at a transverse angle (e.g., 90 degrees) to form a T-shaped profile, as shown in FIG. 1a, Detail A. In this configuration, the first plate 106 is designed to slide between the leg members 118, while the second plate 108 serves as a push plate.

The interface between each latch 110 and the mechanical stops 116 allows for low insertion force while maintaining high pull-off strength and strong slide resistance, owing to the broad surface contact between the latch and the mechanical stops.

The internal geometry of the pocket 130 may optionally include a flexible retention structure 132 that resists axial sliding of the retained object without substantially contributing to the clamping force. In the illustrated example, the flexible retention structure 132 is configured as a resilient ridge extending laterally across the width of the lid 126. This structure may span approximately two-thirds or the full width of the lid 126, depending on the implementation.

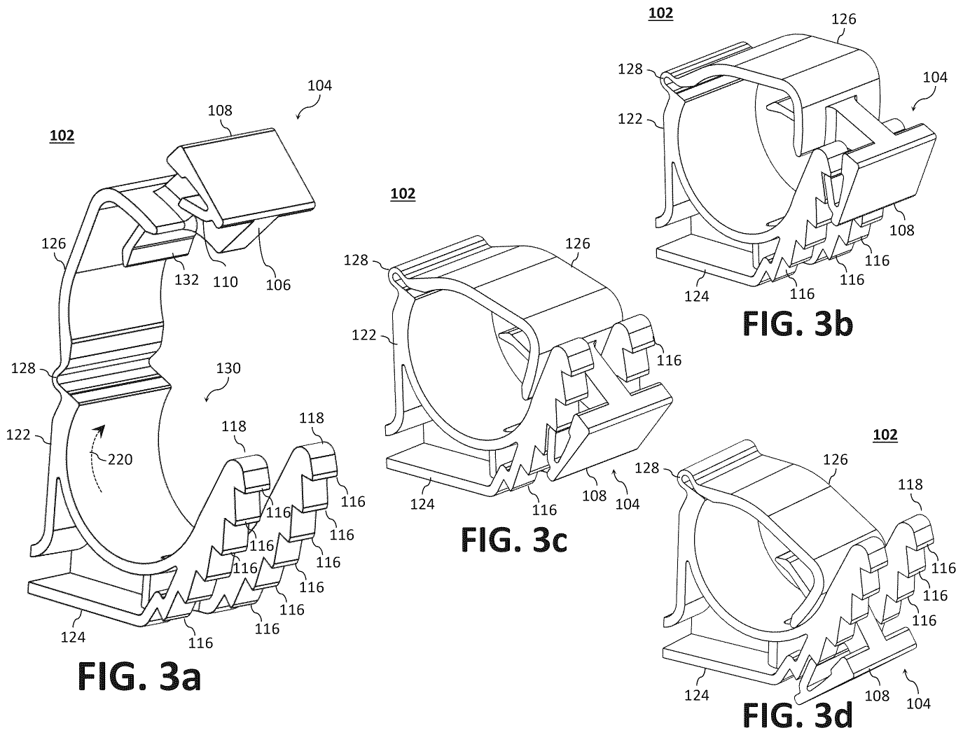

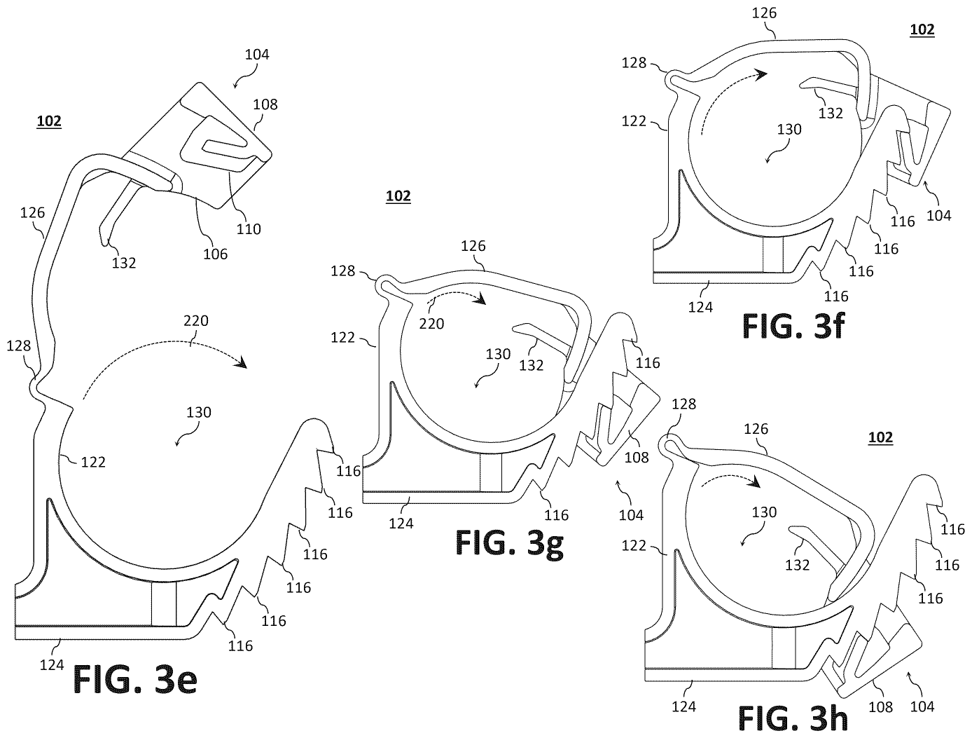

FIGS. 3a through 3d illustrate top isometric views of the multi-stop retainer 102 in the open position, and in first, second, and third closed positions, respectively, while FIGS. 3e through 3h provide corresponding side elevation views.

The multi-stop retainer 102 enables the retention of objects 114 of varying diameters using a single clip design. The modular nature of the multi-stop retainer 102 allows for diameter-specific tuning by modifying stop geometry, location, or quantity, thereby supporting diverse applications while reducing tooling complexity and part proliferation for OEMs.

Accordingly, each of the illustrated closed positions corresponds to a different clamping configuration that accommodates objects 114 of varying diameters. Specifically, the first closed position (FIG. 3b) is coupled to engage the mechanical stop 116 at the distal end (the free end) and is configured to secure the largest object diameter within the system's intended range, while the third closed position (FIG. 3d) is coupled to engage the mechanical stop 116 at the proximal end (adjacent the base) and to secure the smallest object diameter. The second closed position (FIG. 3c) represents an intermediate clamping state that can be adjusted to accommodate objects of medium size or those falling between the largest and smallest diameter ranges.

During insertion, guide features reduce friction for low-force installation and ensure a smooth user experience. In one example, a chamfered end on each leg member 118 assists with proper insertion into the ratchet coupler 104. As the leg members 118 are inserted, the latches 110 engage the mechanical stops 116. The spacing and number of mechanical stops 116 can be adjusted to provide a desired granularity of adjusting between the first closed position (FIG. 3b) and the second closed position (FIG. 3c).

In some cases, a textured surface may be provided on the second plate 108 to enhance grip during tightening. The second plate 108 thus facilitates the user's ability to apply a closing force. To release the fastener, the user applies force to the second plate 108 in a direction opposite to the closing direction, thereby disengaging the latches 110 from the mechanical stops 116.

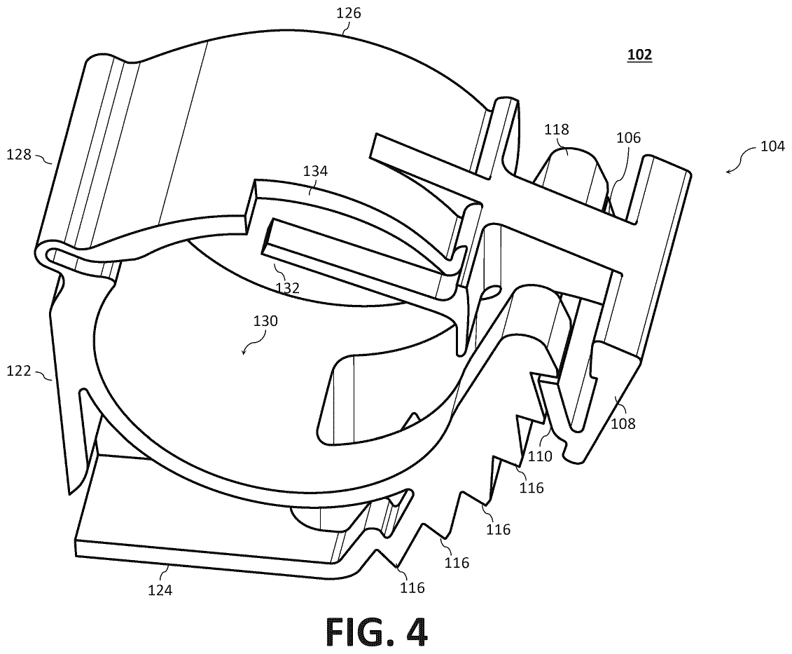

FIG. 4 illustrates a top isometric view of the multi-stop retainer 102 in a first closed position, in accordance with another aspect of this disclosure. In some examples, the flexible retention structure 132 may be configured as a narrow, linear protrusion extending from a cutout 134 formed in the lid 126 and into the internal geometry of the pocket 130.

FIGS. 5a and 5b present isometric and side elevation views, respectively, of the multi-stop fastener 102 in the open position, while FIGS. 5c through 5e depict side elevation views in first, second, and third closed positions, respectively.

The multi-stop fastener 102 shown in FIGS. 5a through 5e is substantially similar to that of FIGS. 2a through 2h, except for the configuration of the leg members 118 (designated as first leg member 118a and second leg member 118b) and the latches 110 (designated as first latch 110a and second latch 110b).

In this example, and with reference to FIG. 5b, the first leg member 118a and second leg member 118b are vertically offset by a first distance D₁. In other words, the pair of leg members 118a, 118b comprises a first leg member 118a parallel to a second leg member 118b that is offset vertically by a first distance D₁ relative to the first leg member 118a. Correspondingly, the ratchet coupler 104 comprises a first latch 110a configured to engage the first leg member 118a and a second latch 110b configured to engage the second leg member 118b. The illustrated first latch 110a and second latch 110b are vertically offset by a second distance D₂, enabling each to engage its respective leg member (e.g., simultaneously). Additionally, the mechanical stops 116 may differ in spacing and size.

In this configuration, while the mechanical stops 116 on the second leg member 118b are uniformly spaced, the stops on the first leg member 118a are non-uniformly spaced. For instance, the distal end of the first leg member 118a features larger stops spaced further apart, whereas five smaller, closely spaced stops are located near the end connected to the base 122.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A multi-stop retainer configured to secure objects of varying diameters, the multi-stop retainer comprising:
a lid coupled to a base via a hinge at a first end and comprising a ratchet coupler at a second end of the lid, wherein the ratchet coupler comprises a first latch and a second latch;
a first leg member coupled to the base and comprising a first plurality of mechanical stops along its length that are configured to interface with the first latch; and
a second leg member coupled to the base and comprising a second plurality of mechanical stops along its length that are configured to interface with the second latch, and
wherein the first leg member and the second leg member are parallel relative to one another, and
wherein the lid is configured to pivot via the hinge to define a pocket configured to be sized for securing an object via the ratchet coupler, the first leg member, and the second leg member.

2. The multi-stop retainer of claim 1, wherein the ratchet coupler is configured to engage the first leg member and the second leg member simultaneously.

3. The multi-stop retainer of claim 1, wherein the first plurality of mechanical stops is uniformly spaced.

4. The multi-stop retainer of claim 1, wherein the first plurality of mechanical stops is non-uniformly spaced.

5. The multi-stop retainer of claim 1, further comprising a flexible retention structure disposed within the pocket and configured to enhance slide resistance.

6. The multi-stop retainer of claim 1, wherein each of the first latch and the second latch is a J-shaped latch.

7. A multi-stop retainer configured to secure objects of varying diameters, the multi-stop retainer comprising:
a lid coupled to a base via a hinge at a first end and comprising a ratchet coupler at a second end of the lid; and
a pair of leg members,
wherein each of the pair of leg members comprises a plurality of mechanical stops along its length, and
wherein the plurality of mechanical stops is configured to interface with the ratchet coupler to define a pocket configured to be sized for securing an object.

8. The multi-stop retainer of claim 7, wherein the ratchet coupler is configured to engage each of the pair of leg members simultaneously.

9. The multi-stop retainer of claim 7, wherein the plurality of mechanical stops is non-uniformly spaced.

10. The multi-stop retainer of claim 7, wherein the plurality of mechanical stops is uniformly spaced.

11. The multi-stop retainer of claim 7, further comprising a flexible retention structure disposed within the pocket and configured to enhance slide resistance.

12. The multi-stop retainer of claim 11, wherein the flexible retention structure is a resilient ridge extending laterally across a majority of a width of the lid.

13. The multi-stop retainer of claim 11, wherein the flexible retention structure is a linear protrusion extending transversely relative to a width of the lid.

14. The multi-stop retainer of claim 13, wherein the linear protrusion extends from a cutout formed in the lid.

15. The multi-stop retainer of claim 7, wherein the ratchet coupler comprises a first latch and a second latch.

16. The multi-stop retainer of claim 15, wherein the ratchet coupler comprises a first plate that is transverse relative to a second plate, wherein the first latch and the second latch are coupled to the second plate and configured to engage one or more of the plurality of mechanical stops.

17. The multi-stop retainer of claim 16, wherein the first plate is positioned between the first latch and the second latch.

18. The multi-stop retainer of claim 15, wherein each of the first latch and the second latch is a J-shaped latch.

19. The multi-stop retainer of claim 7, wherein the pair of leg members comprises a first leg member parallel to a second leg member that is offset vertically by a first distance relative to the first leg member.

20. The multi-stop retainer of claim 19, wherein the ratchet coupler comprises a first latch configured to engage the first leg member, and a second latch configured to engage the second leg member.
